(19) United States
(12) Patent Application Publication
(10) Pub. No.: US 2019/0069032 A1
(43) Pub. Date: Feb. 28, 2019

(54) METHOD FOR PROVIDING COMMERCE ADVERTISEMENT INFORMATION USING STILL IMAGE OF IMAGE CONTENT

(71) Applicant: FINGERPLUS INC., Seoul (KR)

(72) Inventor: Sung Min JIN, Seoul (KR)

(73) Assignee: FINGERPLUS INC., Seoul (KR)

(21) Appl. No.: 16/106,670

(22) Filed: Aug. 21, 2018

Related U.S. Application Data
(63) Continuation of application No. PCT/KR2017/001758, filed on Feb. 17, 2017.

(30) Foreign Application Priority Data
Feb. 24, 2016 (KR) 10-2016-0021605

(51) Int. Cl. H04N 21/4725; H04N 5/272; H04N 21/81; H04N 21/472; H04N 21/431; H04N 21/478

(52) U.S. Cl. CPC H04N 21/4725; H04N 5/272; H04N 21/47815; H04N 21/47217; H04N 21/4316; H04N 21/812

(57) ABSTRACT

According to an embodiment of the inventive concept, a method for providing, by a user terminal, commercial advertisement information using a still image of a video content may include: upon receiving a request to stop playback of the video content while the video content is being played back, switching a played image of the video content into a still image; displaying at least one marker respectively corresponding to at least one object in the still image on at least one position in the still image corresponding to the at least one object; and upon receiving a selection of a specific marker among the displayed at least one marker, displaying commercial advertisement information on an object corresponding to the specific marker.

### CROSS-REFERENCE TO RELATED APPLICATIONS

The present application is a continuation of International Patent Application No. PCT/KR2017/001758, filed on Feb. 17, 2017, which is based upon and claims the benefit of priority to Korean Patent Application No. 10-2016-0021605, filed on Feb. 24, 2016. The disclosures of the above-listed applications are hereby incorporated by reference herein in their entirety.

### BACKGROUND

Embodiments of the inventive concept described herein relate to a method for providing commercial advertisement information using a still image of a video content, and more particularly, relate to a method by which, upon receiving a playback stop request of a video content during a playback thereof, a video content is switched into a still image, and, then, upon receiving a selection of a specific marker corresponding to an object in the still image, commercial advertisement information about the object is displayed.

In recent years, a video content such as a TV program, a user created content (UCC), a music video, and the like is rapidly being shared on the Internet, thanks to development of video and Internet technologies.

Accordingly, the above-mentioned videos are provided or shared to a number of other users. Also, as described above, with the development of the Internet technology, other users who watch the video content are also increasing.

In one example, as shown in FIG. 1, the users watching the video content may be interested in a specific object displayed in a playback screen of the video content during watching of the video contents (S101). Herein, the object may mean at least one specific object displayed in the playback screen of the video content, such as items related to a product such as a hat, a bag, a pants, a wall clock, a cleaner, and the like, and items related to a place such as a cafe, an amusement park, an alley, and the like.

That is, when the users are interested in the specific object while watching the video content, it is frequent that recent days, most of the users first stop watching the video content, then leave an area where the video content is provided and execute a separate search engine, and then search the specific object via the search engine (S102).

In addition, in such a case, the users often do not know the exact name of the specific object. Accordingly, most of the users are only able to indirectly search the specific object using characteristics of the specific object or a title of the video content. Thus, it makes it difficult to find accurate search results. Therefore, there is a problem that the users are required to search repeatedly and continuously (S106).

Even though the users succeed in searching for the specific object through the indirect search as described above, the users may search for the specific object only after leaving the area where the video content is being provided as described above. Thus, purchase of the object may only be made through a purchase procedure using a separate area. After that, there is an inconvenience that it is necessary to return to the area where the video content is provided to continue watching the video content (S104 to S105).

Therefore, a method for solving the above problems is required.

### SUMMARY

A purpose of the inventive concept is to provide a method for providing commercial advertisement information using a still image of a video content so as to solve the above-mentioned problems.

Another purpose of the inventive concept is to provide a method for displaying at least one marker corresponding to at least one object in a still image of a video content on at least one position in the still image corresponding to the at least one object.

Another purpose of the inventive concept is to provide a method by which, upon receiving a selection of a specific marker among at least one or more markers displayed in a still area of a video content, commercial advertisement information about an object corresponding to the specific marker is displayed.

Still another purpose of the inventive concept is to, when commercial advertisement information linked with a specific object in currently played image exists, provide a method for displaying a predetermined identifier in a specific area in the played image.

Yet another object of the inventive concept is to provide a method by which, when commercial advertisement information about a specific object is displayed through a still image of a video content, displayed commercial advertisement information is configured to allow a payment for the object to be carried out, and to allow the commercial advertisement information to be shared over a social network service.

The technical problems of the inventive concept are not limited to the above-mentioned technical problems. Other technical problems not mentioned may be clearly understood by those skilled in the art to which the inventive concept belongs through the following description.

Embodiments of the inventive concept provide a method for providing, by a user terminal, commercial advertisement information using a still image of a video content for solving the above-mentioned problems including: upon receiving a request to stop playback of the video content while the video content is being played back, switching a played image of the video content into a still image; displaying at least one marker respectively corresponding to at least one object in the still image on at least one position in the still image corresponding to the at least one object; and upon receiving a selection of a specific marker among the displayed at least one marker, displaying commercial advertisement information on an object corresponding to the specific marker.

According to an aspect of an embodiment of the method, displaying the at least one marker further includes: inquiring whether pre-linked commercial advertisement information exists in a still frame corresponding to the still image among at least one frame constituting the video content; and upon inquiry that the pre-linked commercial advertisement information exists, displaying the marker respectively corresponding to an object linked with the pre-linked commercial advertisement information in an overlapping manner with the object in the still image.

According to another aspect of an embodiment of the method includes: inquiring, during playback of the video content composed of at least one frame, whether pre-linked commercial advertisement information exists in a played frame corresponding to a currently played image; and upon inquiry that the pre-linked commercial advertisement information exists, displaying a predetermined identifier in a specific area in the currently played image.

According to another aspect of an embodiment of the method, the identifier displayed in the currently played image remains during playback of the played frame among the at least one frame.

According to another aspect of an embodiment of the method, upon receiving the playback stop request while the identifier is displayed on the played image, the played image is switched to the still image, and the at least one marker respectively corresponding to the at least one object in the still image is displayed in an overlapping manner with the corresponding at least one object in the still image.

According to another aspect of an embodiment of the method, displaying the commercial advertisement information includes: determining which of a left or right region with respect to a central axis corresponding to a center of the still image contains the input specific marker; upon determination that the left region contains the specific marker, displaying the commercial advertisement information on the right region; or upon determination that the right region contains the specific marker, displaying the commercial advertisement information on the left region.

According to another aspect of an embodiment of the method, the displayed commercial advertisement information includes specification on the object.

According to another aspect of an embodiment of the method, the displayed commercial advertisement information is configured to allow a payment for the object to be carried out.

According to another aspect of an embodiment of the method, the displayed commercial advertisement information is configured to allow the commercial advertisement information to be shared over a social network service.

According to another aspect of an embodiment, the method further comprises, upon receiving a playback request of the video content while the marker or the commercial advertisement information is displayed, switching the still image back to a played image such that the video content is played back.

### BRIEF DESCRIPTION OF THE FIGURES

The above and other objects and features will become apparent from the following description with reference to the following FIGS., wherein like reference numerals refer to like parts throughout the various FIGS. unless otherwise specified, and wherein:

FIG. 1 is an exemplary view illustrating a situation that may occur when a user is interested in a specific object while watching a video content in a prior art.

FIG. 2 is a diagram illustrating a wireless communication network system to which the inventive concept may be applied;

FIG. 3 is a flowchart illustrating a method for providing commercial advertisement information using a still image of a video content according to an embodiment of the inventive concept;

FIG. 4 is a diagram of the inventive concept in which, when commercial advertisement information pre-linked with a specific object in a currently played image exists, illustrates an identifier displayed in a specific area in the playback video;

FIGS. 5A and 5B illustrate at least one marker displayed corresponding to at least one object in a still image of a video content, and commercial advertisement information about a specific object linked with the marker according to an embodiment of the inventive concept;

FIG. 6A to FIG. 6C are diagrams for illustrating a method for displaying commercial advertisement information on a still image of a video content according to an embodiment of the inventive concept; and

FIG. 7 is a block diagram illustrating an exemplary configuration of a user terminal and a server that realize a method according to an embodiment of the inventive concept.

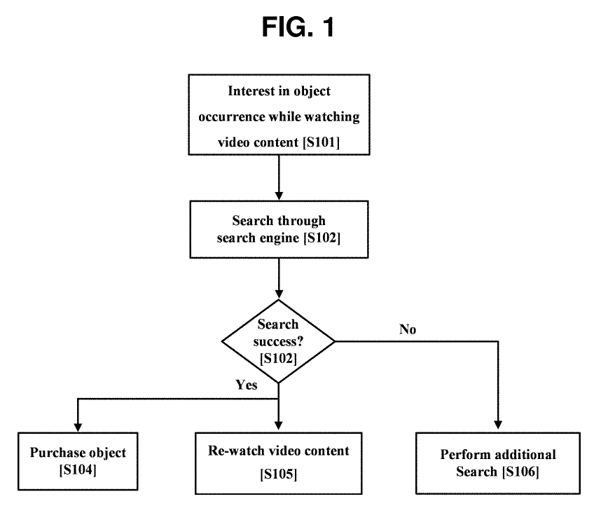

### DETAILED DESCRIPTION

Hereinafter, preferable embodiments of the inventive concept will be described in detail with reference to the accompanying drawings. The following detailed description, together with the accompanying drawings, set forth below is intended to illustrate exemplary embodiments of the inventive concept, and is not intended to represent the only embodiments in which the inventive concept may be constructed.

The embodiments of the inventive concept are provided to only make the disclosure of the inventive concept complete and to fully inform those skilled in the art to the scope of the inventive concept. The inventive concept will be defined only by the scope of the appended claims.

In some instances of describing the inventive concept, well-known structures and devices may be omitted or shown in block diagram form to avoid obscuring the description of the inventive concept with unnecessary detail. In addition, the same reference numerals denote the same elements throughout the specification.

Throughout the specification, when a part “includes” or “comprises” an element, unless there is a particular description contrary thereto, the part may further include other elements, not excluding the other elements.

Terms such as “unit”, and the like used herein may mean a unit for processing at least one function or operation. Also, “unit”, and the like may be implemented as hardware or software, or a combination thereof. Moreover, as used herein, the singular forms “a,” “an,”, “one”, and the like are intended to include the plural forms as well, unless the context clearly indicates otherwise.

Additionally, the specific terms used in the following embodiments of the inventive concept are provided to facilitate the understanding of the inventive concept. Unless otherwise defined, all terms (including technical and scientific terms) used herein have the same meaning as commonly understood by those skilled in the art to which the inventive concept pertains. Without deviating from the technical scope and spirit of the inventive concept, such specific terms may also be varied and/or replaced by other terms.

Hereinafter, preferred embodiments according to the inventive concept will be described in detail with reference to the accompanying drawings. The following detailed description, together with the accompanying drawings, set forth below is intended to illustrate exemplary embodiments of the inventive concept, and is not intended to represent the only embodiments in which the inventive concept may be constructed.

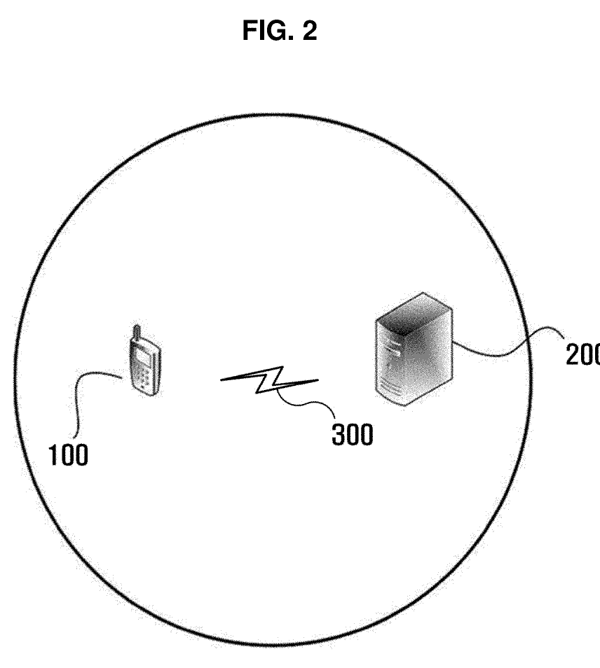

FIG. 2 is a diagram illustrating a wireless communication network system to which the inventive concept may be applied.

With reference to FIG. 2, the wireless communication system to which the inventive concept may be applied may be composed of a user terminal 100, a server 200, and a network 300.

However, the wireless communication network system described below includes at least one of the components shown in FIG. 2, but is not limited thereto. In the wireless communication network system to which the inventive concept may be applied, there may be at least one terminal, at least one server (for example, a relay server, a mediation server, and a client server), and at least one network. In addition, each terminal and server may be connected through different networks.

The user terminal 100 is a device capable of transmitting and receiving a communication signal in an embodiment of the inventive concept. In the inventive concept, the user terminal 100 may be interpreted as a concept including all terminals that are capable of transmitting and receiving both data and information.

In this connection, the user terminal 100 may have at least one program or application installed therein. In particular, an application including an application program interface (API) or embedded software related to a method for providing commercial advertisement information using a still image of a video content according to an embodiment of the inventive concept may be installed in the user terminal 100.

The user terminal 100 may transmit or receive data or a signal to or from the server 200 by its own, or via at least one program or application installed therein. The transmitted or received data or signal may be related to wireless router access information according to an embodiment of the inventive concept.

As an example of the user terminal 100, a PC (Personal Computer), a laptop computer, a tablet PC, a terminal device, a terminal, a MS (Mobile Station), a MSS (Mobile Subscriber Station), a SS (Subscriber Station), an AMS (Advanced Mobile Station), a WT (Wireless terminal), a MTC (Machine-Type Communication) device, a M2M (Machine-to-Machine) device, and a D2D (Device-to-Device) device may be included.

Of course, this is merely an example, and the user terminal in the inventive concept should be interpreted as a concept that includes all devices capable of transmitting data or a signal that are currently developed and commercialized, or to be developed in the future.

With reference to FIG. 2 again, the server 200 refers to an object capable of transmitting and receiving data with at least one other device through the wireless communication network. In the inventive concept, the server 200 may further include the relay server, the mediation server, and/or the client server.

In addition, as an example of the server 200, a cloud server, an IMS (IP Multimedia Subsystem) server, a telephony application server, an IM (Instant Messaging) server, a MGCF (Media Gateway Control Function) server, a MSG (Messaging Gateway) server, a CSCF (Call Session Control Function) server may be included. Further, the server 200 may be implemented with a device that is capable of transmitting and receiving data, such as a PC (Personal Computer), a laptop computer, or a tablet PC.

In this connection, the network 300 refers to a data communication network for transmitting and receiving data between the user terminal 100 and the server 200, and a type thereof is not particularly limited.

For example, it may be an IP (Internet Protocol) network that provides a large capacity data transmission/reception service through an Internet Protocol (IP), or may be an All IP network that integrates different IP networks.

In addition, the network 300 may include a mobile communication network including a wired network, a Wibro (Wireless Broadband) network, and a WCDMA, a mobile communication network including a High Speed Downlink Packet Access (HSDPA) network, and a Long Term Evolution (LTE) network, a mobile communication network including LTE advanced (LTE-A), and 5G (Five Generation), a satellite communication network, and a Wi-Fi network, or a combination of one or more of them.

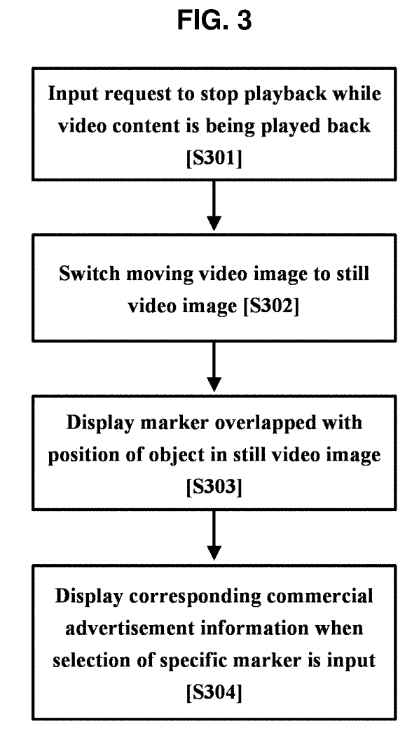

FIG. 3 is a flowchart illustrating a method for providing commercial advertisement information using a still image of a video content according to an embodiment of the inventive concept.

With reference to FIG. 3, when a video content composed of at least one frame is being played, when the user terminal receives a request to stop playback of the video content, the user terminal may stop the playback of the video content, thereby switching a played image of the video content to a still image (S301 to S302).

That is, when the user is watching the video content being played, the user may be interested in a specific object displayed on a screen of the video content.

For example, while watching video content such as a tv show, a variety show, or a movie, the user may have an interest in a small item such as shoes or a bag worn by a character in the corresponding video content, or may be curious about a specific place visited by the characters.

In this case, most of the conventional users spend an extra amount of time after completing the watching of the video content to perform searches, and the like on the object that has become interested. Otherwise, it is often that the user pauses the currently played video content (or maintain the playback state), and leaves the area where the video content are played to search the object that has become interested through an internet search engine, or the like.

However, even though the search for the object is performed as described above, it is common that the search fails because exact name or characteristic of the object which is just instantaneously appeared in the video content may not be grasped to the user.

In addition, even though the search for the object succeeds, there has been a problem that the video content may not be continuously watched for the consumed time because the user has to spend a large amount of time for the search in most cases.

Accordingly, the inventive concept aims to provide a method for providing commercial advertisement information using the still image of the video content in order to solve the above-mentioned problem.

In accordance with the inventive concept as described above, the user may be provided with commercial advertisement information on the specific object in the playback screen of the video content even though the user does not separately search the corresponding object through the search engine. Further, since the commercial advertisement information may be provided while continuing the watching of the video content, the commercial advertisement information may be obtained more conveniently.

In addition, in the inventive concept, most of all, the commercial advertisement information is provided to the user only after the playback screen of the video content is switched to the still image. Thus, the user may not miss the video content even though the user views the commercial advertisement information.

Hereinafter, the method for providing the commercial advertisement information using the still image of the video content according to an embodiment of the inventive concept having the above-mentioned advantage and effect, will be described in more detail.

With reference to FIG. 3 again, when the user input the request to stop playback of the video content being played back, the user terminal may stop the playback of the video content, and switch the played image of the video content to the still image.

In addition, after switching the played image to the still image, the user terminal may display at least one or more markers corresponding to at least one or more objects in the still image in area where each of the objects in the still image is located (S303).

Herein, the object may mean at least one specific object displayed in the playback screen of the video content. The object may include an item such as a hat, a bag, pants, a wall clock, a cleaner, and the like that is worn or used by the character, and a place such as a cafe, an amusement park, an alley, and the like which is visited by the character, or constitutes the background of the video content. However, the foregoing are only examples, and the object is not limited thereto.

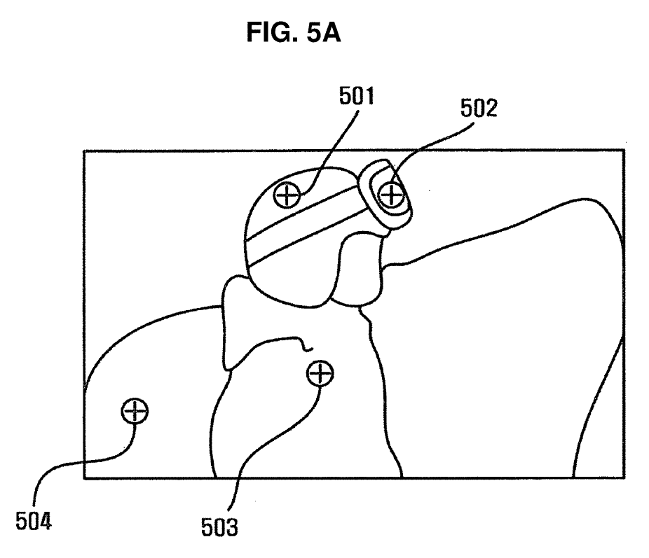

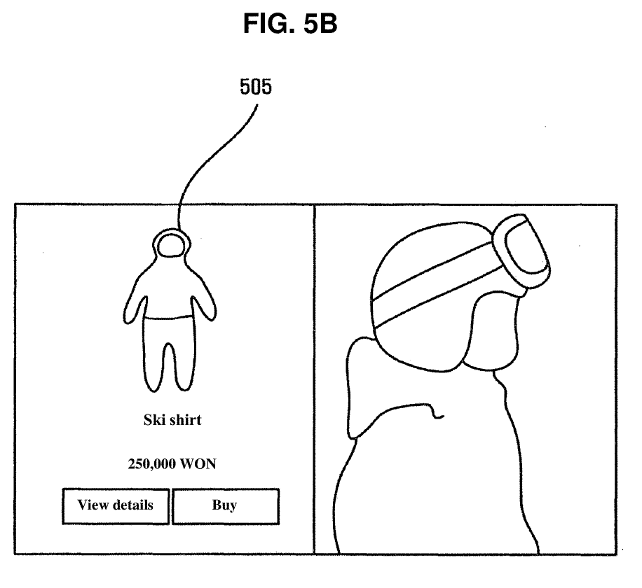

In addition, the marker is a kind of an indicator for indicating the specific object displayed on the screen of the still image. For example, as shown in FIG. 5A, the marker may be interpreted to mean the indicator that may be implemented in various shapes to indicate the object, which is a specific object (for example, a helmet, a goggle, a ski suit, and a ski resort) displayed on the screen of the still image.

In one example, according to an embodiment of the inventive concept, in order to display the marker, the user terminal may first determine whether there is pre-linked commercial advertisement information in the still frame corresponding to the still image among the at least one frame constituting the video content.

In this connection, when the video content of the at least one frame is played back, it may be understood that the playback may mean the at least one frame is displayed sequentially. When the playback stop request is received from the user while a specific frame among the at least one frame is displayed as the video contents is played back, the specific frame, which is switched to the still image depending on the playback stop request becomes a still frame.

Thus, in the inventive concept, the user terminal may inquire whether the pre-linked commercial advertisement information exists in order to display the marker. In this connection, the commercial advertisement information may be linked with the video content in advance during a production of the video content, or before the playback after the production of the video content.

According to an embodiment of the inventive concept, the inquiry may be made through real-time inquiry to an external server pre-linked with the user terminal. The external server may be a server pre-linked with the user terminal to provide the method for providing the commercial advertisement information using the still image of the video content, which is the inventive concept.

Alternatively, the user terminal may receive and store the commercial advertisement information from the external server at predetermined intervals. Accordingly, the inquiry may be made on the commercial advertisement information stored in the user terminal.

In one example, as a result of the inquiry, when there is the pre-linked commercial advertisement information exists, the user terminal may display the marker on an area where an object corresponding to each of the inquired commercial advertisement information is located in the still image. At this time, the marker may be displayed in an overlapping manner with the still image.

For a more detailed description, with reference to FIG. 5A, after the playback stop request of the video content is received, and the played image of the currently played video content is switched to the still image, then, the user terminal may inquire whether the commercial advertisement information pre-linked with the video content exists in the still frame corresponding to the still image in order to display the marker. In the following description with reference to FIG. 5A, it is assumed that the four commercial advertisement information pre-linked with the video content exist in the still frame corresponding to the still image. Each of the four commercial advertisement information is assumed to be about the helmet, the goggle, the ski suit, and the ski resort.

When it is inquired that the commercial advertisement information exists as a result of the inquiry, the user terminal may display the marker for the object (the helmet, the goggle, the ski suit, and the ski resort) corresponding to each of the inquired four commercial advertisement information among a plurality of objects displayed in the still image. The markers may be displayed in areas (501 to 504) in which the objects corresponding to the four commercial advertisement information inquired in the still image are located. In this case, the markers may be overlapped with the still image as shown in FIG. 5A.

In addition, according to an embodiment of the inventive concept, while the marker indicates a specific object displayed on the screen of the still image through the above process, the user may improve an indication accuracy of the marker by performing a drag-drop on the specific marker to adjust the position of the specific marker to more accurately point the object. In contrast, the target object of the marker may be changed for the marker to indicate an object other than the specific object.

With reference to FIG. 3 again, when the user selects a specific marker among at least one marker displayed in areas where objects in the still image are located according to step S303, the user terminal may display commercial advertisement information on an object corresponding to the input specific marker (S304).

For example, as described above in FIG. 5A, when the user inputs to select a marker 503 displayed on the ski suit among markers (501 to 504) displayed on the object (the helmet, the goggle, the ski suit, and the ski resort) corresponding to each of the four inquired commercial advertisement information, the user terminal may display commercial advertisement information about the ski suit corresponding to the input marker 503 as shown in FIG. 5B.

Here, the commercial advertisement information may include descriptive information about the object (for example, when the object is the ski suit, product detailed information such as manufacturer, product name, price, waterproofing rate, washing method, and the like may be included). Further, the commercial advertisement information may provide a payment environment capable of processing a purchase procedure of the object in the corresponding information, or may provide a connection with another web site selling the object.

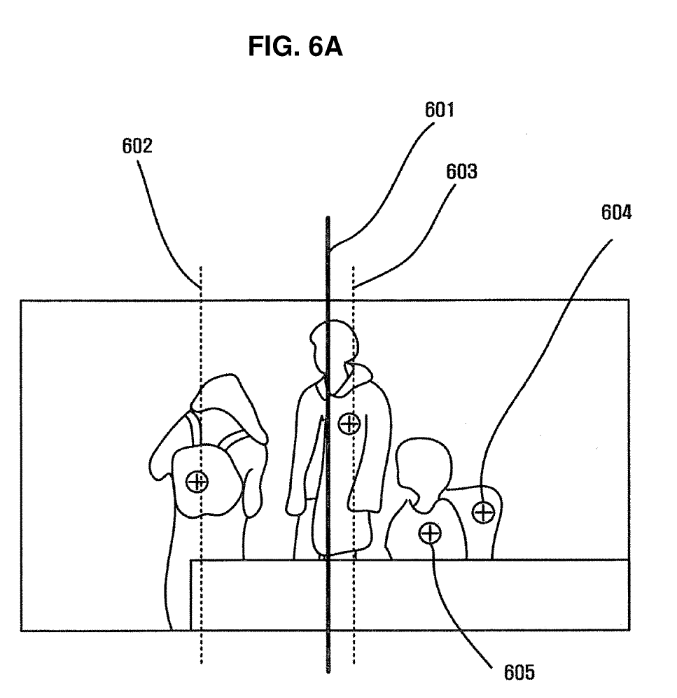

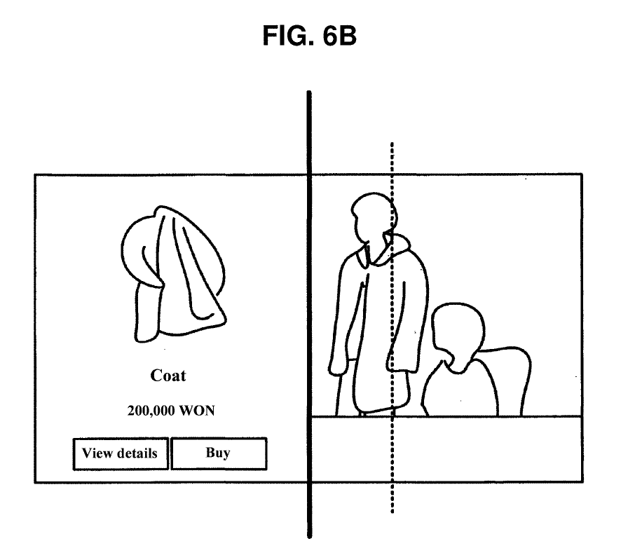

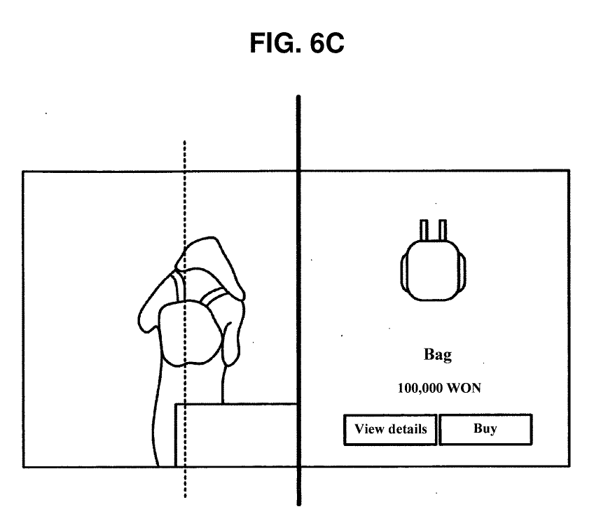

In one example, with reference to FIG. 6A to FIG. 6C, there are shown diagrams illustrating a method for displaying commercial advertisement information in a still image of a video content according to an embodiment of the inventive concept.

When the user terminal displays the commercial advertisement information on the object corresponding to the input specific marker as in step S304, according to an embodiment of the inventive concept, the user terminal may determine which of the left or right region with respect to a central axis corresponding to a center of the still image contains the input specific marker.

As a result of the determination, when the determined position of the specific marker is located on the left region with respect to the central axis, the commercial advertisement information may be displayed on the right region with respect to the central axis. In addition, when the determined position of the specific marker is located on the right region with respect to the central axis, the commercial advertisement information may be displayed on the left region with respect to the central axis.

For a more detailed example, with reference to FIG. 6A, markers 602, 603, 604, and 605 are displayed for four of a plurality of objects displayed in the still image. With reference to a central axis 601 corresponding to a center of the still image, the first marker 602 is located on a left region with respect to the central axis 601, and the remaining second marker 603, the third marker 604, and the fourth marker 605 are located on a right region with respect to the central axis 601.

Accordingly, when the user selects the second marker 603, since the second marker 603 is located on the right region with respect to the center side 601, commercial advertisement information about an object corresponding to the second marker 603 may be displayed on the left region with respect to the central axis 601 as shown in FIG. 6B. At this time, the still image may be displayed on the right region with respect to the central axis 601 together.

When the user selects the first marker 602, since the first marker 602 is located on the left region with respect to the center side 601, commercial advertisement information about an object corresponding to the first marker 602 may be displayed on the right region with respect to the central axis 601 as shown in FIG. 6C. At this time, the still image may be displayed on the left region with respect to the central axis together.

As described above, by determining the relative position of the marker in the still image and controlling the position at which commercial advertisement information is displayed depending on the determination result, blocking of the user's view for the video content due to the display of the commercial advertisement information is prevented.

In one example, according to an embodiment of the inventive concept, when the user terminal receives a playback request for the video content from the user while the marker or the commercial advertisement information is displayed, the video content may be played back by switching the still image to a played image. In addition, depending on the playback, the displayed marker or the commercial advertisement information may be deactivated.

Further, according to an embodiment of the inventive concept, the user of the user terminal may share the commercial advertisement information over the social network service (SNS).

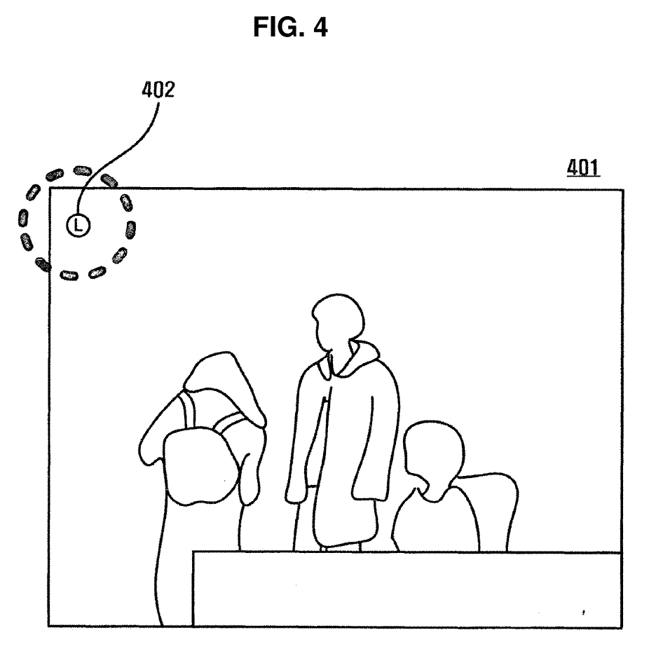

Hereinafter, according to an embodiment of the inventive concept, with reference to FIG. 4, an identifier displayed in a specific area in the played image will be described when commercial advertisement information linked with a specific object in the currently played image exists.

According to an embodiment of the inventive concept, while the video content composed of at least one frame are being played back, the user terminal may inquire whether there is any pre-linked commercial advertisement information in a frame corresponding to the currently played image.

As a result of the inquiry, when the pre-linked commercial advertisement information exists, the user terminal may display a predetermined identifier in a specific area of the currently played image.

A more detailed description is provided with reference to FIG. 4. When the video content composed of the at least one frame is being played, and when the commercial advertisement information pre-linked with the video content is not found in the played frame corresponding to the currently played image, the user terminal may play back the video content as a played image 401, which is not much different from a general played image, as shown in FIG. 4.

However, when it is inquired that commercial advertisement information pre-linked with the video content in the played frame corresponding to the currently played image exists, the user terminal may display a predetermined identifier 402 in a specific area in the currently played image, as shown in FIG. 4, according to an embodiment of the inventive concept.

That is, according to an embodiment of the inventive concept, the user who watches the video content may intuitively know whether the commercial advertisement information pre-linked with the object displayed on the screen of the currently played image exists.

Therefore, when the user watching the video content is interested in a specific object in the currently played image, the user may immediately recognize that the commercial advertisement information about the specific object may be viewed by confirming whether or not the identifier is displayed.

Furthermore, the user who has recognized this fact may easily view the commercial advertisement information on the specific object by switching the played image to a still image by inputting a playback stop request for the video content, and then by selecting the marker displayed on the specific object in the still image.

Further, according to an embodiment of the inventive concept, the identifier indicated in the played image may be remained while the played frame among at least one frame is played back. Accordingly, when a playback stop request for the video content is input until the frame is switched, the commercial advertisement information about the specific object may be viewed.

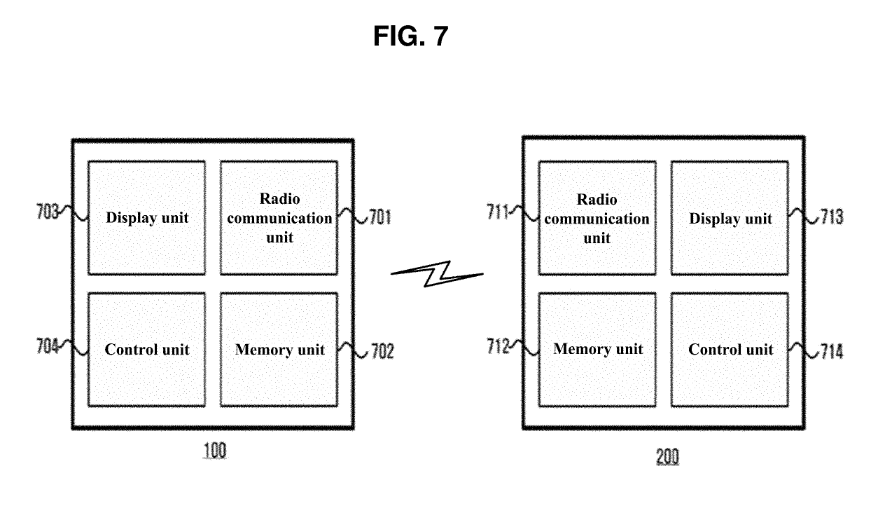

FIG. 7 is a block diagram illustrating an exemplary configuration of a user terminal and a server that form a method according to an embodiment of the inventive concept.

With reference to FIG. 7, a user terminal and a server that may be applied in the inventive concept are shown. Although only one user terminal and one server are shown in FIG. 7, at least one user terminal and server may be included.

The server 200 may include a radio communication unit 711 including a transmitting unit and a receiving unit capable of transmitting and receiving data or information, a memory unit 712, a display unit 713, and a control unit (or a processor) 714. However, this is merely an example, and other configurations than the configuration shown in FIG. 7 may be further included, or alternately some of the configuration shown in FIG. 7 may be omitted.

Further, an overall process of data communication with the user terminal 100 such as signal processing and layer processing of the server 200 may be controlled by the memory unit 712 and the control unit 714. In addition, a connection relationship may be established among the memory unit 712, the radio communication unit 711, and the control unit 714.

The radio communication unit 711 included in the server 200 may include the transmitting unit and the receiving unit as described above. In addition, the transmitting unit and the receiving unit may be configured to transmit and receive data or a signal between the user terminal 100 and the server 200.

The control unit 714 may be configured to operatively connect to the transmitting unit and the receiving unit in the radio communication unit, and to allow the transmitting unit and the receiving unit to control the process of transmitting and receiving the data or signal between the user terminal 100 and the server 200. In addition, the control unit 714 may perform various processes on data to be transmitted, and transmit the data to the transmitting unit. In addition, the control unit 714 may process data received by the receiving unit.

When it is necessary, the control unit 714 may store information contained in exchanged data in the memory unit 712. The server 200 having such a structure may perform various embodiments of the inventive concept described above in FIG. 2 to FIG. 6C.

With reference to FIG. 7, in the user terminal 100, a radio communication unit 701 including a transmitting unit and a receiving unit of the user terminal 100 is configured to transmit and receive data or a signal with the server 200.

In addition, a control unit 704 of the user terminal 100 may be configured to operatively connect to the transmitting unit and the receiving unit, and to allow the transmitting unit and the receiving unit to control the transmission and reception of the data or signal with other devices including the server 200.

In addition, in the inventive concept, the user terminal 100 may include a display unit 703, which displays data, information, or the like, inside or outside the user terminal 100.

The display unit 703 displays and outputs information processed by the user terminal 100. Specifically, the display unit 703 may display a video content, commercial advertisement information, data or information received from the server, and the like, and those may be displayed by a UI (User Interface), a GUI (Graphic User Interface), or the like.

In addition, the display unit 703 may include at least one of a liquid crystal display, a thin film transistor-liquid crystal display, an organic light-emitting diode, a flexible display, and a 3D display. Depending on implementation, two or more display units may exist. For example, the user terminal 100 may include an external display unit and an internal display unit at the same time.

In one example, the control unit 704 may perform various processes on data or a signal to be transmitted, and may transmit the processed data to the transmitting unit. In addition, the control unit 704 may process data or a signal received by the receiving unit.

When it is necessary, the control unit 704 may store information contained in exchanged data in the memory 703.

The control units 704 and 714 of the user terminal 100 and the server 200 may direct (for example, control, adjust, manage, and the like) operations of the user terminal 100 and the server 200. In addition, each of the control units 704 and 714 may also be connected to the memory units 702 and 712 capable of storing program codes and data.

The memory units 702 and 712 may be connected to the control units 704 and 714 to store an operating system, an application, and general files.

The control units 704 and 714 of the inventive concept may be referred to as a processor, a controller, a microcontroller, a microprocessor, a microcomputer, and the like. In one example, the control units 704 and 714 may be implemented by a hardware or a firmware, a software, or a combination thereof.

In an implementation of the firmware or the software, an embodiment of the inventive concept may be implemented in a form of a module, a procedure, a function, and the like that performs the above described functions or operations. A software code may be stored in the memory units 702 and 712, and driven by the control units 704 and 714. The memory unit may be located inside or outside the user terminal 100 and the server 200, and may exchange data with the control units 704 and 714 by various well-known means.

In one example, the above-described method may be written as a program that may be executed in a computer, and may be implemented in a general purpose digital computer capable of executing the program using a computer readable medium. In addition, a structure of the data used in the above-described method may be recorded on the computer-readable medium through various means. The computer readable medium for storing executable computer code for performing the various methods of the inventive concept includes a storage medium such as a magnetic storage medium (for example, a ROM, a floppy disk, a hard disk, and the like), and an optical readable medium (for example, a CD-ROM, DVD, and the like).

According to the inventive concept as described above, following effects may be obtained. However, the effects may be obtained through the inventive concept are not limited to those.

First, according to the inventive concept, a method for providing commercial advertisement information using a still image of a video content may be provided.

Second, according to the inventive concept, a method for displaying at least one marker corresponding to at least one object in a still image on at least one position in the still image corresponding to the at least one object may be provided.

Third, according to the inventive concept, a method by which, receiving a selection of a specific marker among at least one marker displayed in a still region of a video content, commercial advertisement information on an object corresponding to the specific marker is displayed may be provided.

Fourth, according to the inventive concept, a method by which, even though user terminals having different screen sizes playback a moving image including the additional content, the additional content is displayed in positions having the same ratio between vertical and horizontal dimension between the user terminals using coordinate information about the additional content as input may be provided.

The effects may be obtained in the inventive concept may be not limited to the effects mentioned above, and other effects not mentioned may be clearly understood through the following description to those skilled in the art to which the inventive concept belongs.

It will be understood by one of ordinary skill in the art that various changes in form and details may be made therein without departing from the spirit and scope of the inventive concept. Thus, the disclosed methods should be considered as illustrative rather than limitative of the inventive concept. Therefore, the scope of the inventive concept is defined not by the detailed description of the inventive concept but by the appended claims, and any differences within the scope of the claims will be construed as being included in the inventive concept.

What is claimed is:

1. A method for providing, by a user terminal, commercial advertisement information using a still image of a video content, the method comprising:
upon receiving a request to stop playback of the video content while the video content is being played back, switching a played image of the video content into a still image;
displaying at least one marker respectively corresponding to at least one object in the still image on at least one position in the still image corresponding to the at least one object; and
upon receiving a selection of a specific marker among the displayed at least one marker, displaying commercial advertisement information on an object corresponding to the specific marker.

2. The method of claim 1, wherein the displaying of the at least one marker further includes:
inquiring whether pre-linked commercial advertisement information exists in a still frame corresponding to the still image among at least one frame constituting the video content; and
upon inquiry that the pre-linked commercial advertisement information exists, displaying the marker respectively corresponding to an object linked with the pre-linked commercial advertisement information in an overlapping manner with the object in the still image.

3. The method of claim 1, further comprising:
inquiring, during playback of the video content composed of at least one frame, whether pre-linked commercial advertisement information exists in a played frame corresponding to a currently played image; and
upon inquiry that the pre-linked commercial advertisement information exists, displaying a predetermined identifier in a specific area in the currently played image.

4. The method of claim 3, wherein the identifier displayed in the currently played image remains during playback of the played frame among the at least one frame.

5. The method of claim 4, wherein upon receiving the playback stop request while the identifier is displayed on the played image, the played image is switched to the still image, and the at least one marker respectively corresponding to the at least one object in the still image is displayed in an overlapping manner with the corresponding at least one object in the still image.

6. The method of claim 1, wherein the displaying of the commercial advertisement information includes:
determining which of a left or right region with respect to a central axis corresponding to a center of the still image contains the input specific marker;
upon determination that the left region contains the specific marker, displaying the commercial advertisement information on the right region; or
upon determination that the right region contains the specific marker, displaying the commercial advertisement information on the left region.

7. The method of claim 1, wherein the displayed commercial advertisement information includes specification on the object.

8. The method of claim 1, wherein the displayed commercial advertisement information is configured to allow a payment for the object to be carried out.

9. The method of claim 1, wherein the displayed commercial advertisement information is configured to allow the commercial advertisement information to be shared over a social network service.

10. The method of claim 1, wherein the method further comprises, upon receiving a playback request of the video content while the marker or the commercial advertisement information is displayed, switching the still image back to a played image such that the video content is played back.
